(19) United States
(12) Patent Application Publication
(10) Pub. No.: US 2017/0159494 A1
(43) Pub. Date: Jun. 8, 2017

(54) STEAM TURBINE NOZZLE SEGMENT WITH COMPLETE SIDEWALL AND INTEGRATED HOOK DESIGN

(71) Applicant: General Electric Company, Schenectady, NY (US)

(72) Inventor: Steven Sebastian Burdgick, Schenectady, NY (US)

(21) Appl. No.: 14/960,914

(22) Filed: Dec. 7, 2015

(51) Int. Cl. F01D 25/24; F01D 9/04; F01D 5/02

(52) U.S. Cl. CPC F01D 25/246; F01D 5/02; F01D 9/041; F05D 2220/31; F05D 2240/128; F05D 2260/30

(57) ABSTRACT

Various embodiments include a steam turbine diaphragm nozzle segment, related assembly and steam turbine. Particular embodiments include a steam turbine diaphragm nozzle segment having: an airfoil having a contact surface for directing a flow of working fluid through a flow path; and a sidewall coupled with the airfoil and at least partially radially outboard of the airfoil, the sidewall having: a body contacting the airfoil; an axially upstream-extending hook extending axially from the body; a first notch adjacent the axially upstream-extending hook; an axially downstream-extending hook extending axially from the body; and a second notch adjacent the axially downstream-extending hook.

### BACKGROUND OF THE INVENTION

The subject matter disclosed herein relates to steam turbines. Specifically, the subject matter disclosed herein relates to nozzle segments in steam turbines. Steam turbines include static nozzle assemblies that direct flow of a working fluid into turbine buckets connected to a rotating rotor. The nozzle construction (including a plurality of nozzles, or “airfoils”) is sometimes referred to as a “diaphragm” or “nozzle assembly stage.” Steam turbine diaphragms include two halves, which are assembled around the rotor, creating horizontal joints between these two halves. Each turbine diaphragm stage is vertically supported by support bars, support lugs or support screws on each side of the diaphragm at the respective horizontal joints. The horizontal joints of the diaphragm also correspond to horizontal joints of the turbine casing, which surrounds the steam turbine diaphragm.

Current approaches for welding airfoils to nozzle rings (or, sidewalls) have shortcomings. Specifically, large stage diaphragms, such as those found in the low pressure section of a steam turbine (with airfoil lengths typically greater than ˜45 centimeters (˜18 inches)) pose welding issues. For example, these welds are prone to cracking, and can be labor intensive to form. Additionally, conventional welding approaches often involve a post-weld heat treatment. Even further, welding causes distortion in the steam flow path, which can negatively impact performance. Approaches to work around the weld configurations (e.g., integrated sidewall-airfoil designs) have been lacking in that they require additional components and fabrication in order to effectively cover the forward flow path.

### BRIEF DESCRIPTION OF THE INVENTION

Various embodiments include a steam turbine diaphragm nozzle segment, related assembly and steam turbine. Particular embodiments include a steam turbine diaphragm nozzle segment having: an airfoil having a contact surface for directing a flow of working fluid through a flow path; and a sidewall coupled with the airfoil and at least partially radially outboard of the airfoil, the sidewall having: a body contacting the airfoil; an axially upstream-extending hook extending axially from the body; a first notch adjacent the axially upstream-extending hook; an axially downstream-extending hook extending axially from the body; and a second notch adjacent the axially downstream-extending hook.

A first aspect of the disclosure includes a steam turbine diaphragm nozzle segment having: an airfoil having a contact surface for directing a flow of working fluid through a flow path; and a sidewall coupled with the airfoil and at least partially radially outboard of the airfoil, the sidewall having: a body contacting the airfoil; an axially upstream-extending hook extending axially from the body; a first notch adjacent the axially upstream-extending hook; an axially downstream-extending hook extending axially from the body; and a second notch adjacent the axially downstream-extending hook.

A second aspect of the disclosure includes a steam turbine diaphragm segment having: an outer ring; an inner ring within the outer ring; and at least one diaphragm nozzle segment coupled to the inner ring and the outer ring, the at least one diaphragm nozzle segment having: an airfoil with a contact surface for directing a flow of working fluid through a flow path; a first sidewall coupled with the airfoil and at least partially radially outboard of the airfoil, the first sidewall coupled with the outer ring, wherein the first sidewall includes: a body contacting the airfoil; an axially upstream-extending hook extending axially from the body; a first notch adjacent the axially upstream-extending hook; an axially downstream-extending hook extending axially from the body; and a second notch adjacent the axially downstream-extending hook; and a second sidewall coupling the airfoil with the inner ring.

A third aspect of the disclosure includes a steam turbine having: a rotor; a turbine casing at least partially surrounding the rotor; and a diaphragm segment between the turbine casing and the rotor, the diaphragm segment having: an outer ring; an inner ring within the outer ring; and at least one diaphragm nozzle segment coupled to the inner ring and the outer ring, the at least one diaphragm nozzle segment having: an airfoil with a contact surface for directing a flow of working fluid through a flow path; a first sidewall coupled with the airfoil and at least partially radially outboard of the airfoil, the first sidewall coupled with the outer ring, wherein the first sidewall includes: a body contacting the airfoil; an axially upstream-extending hook extending axially from the body; a first notch adjacent the axially upstream-extending hook; an axially downstream-extending hook extending axially from the body; and a second notch adjacent the axially downstream-extending hook; and a second sidewall coupling the airfoil with the inner ring.

### BRIEF DESCRIPTION OF THE DRAWINGS

These and other features of this invention will be more readily understood from the following detailed description of the various aspects of the invention taken in conjunction with the accompanying drawings that depict various embodiments of the disclosure, in which:

FIG. 1 shows a partial cross-sectional schematic view of steam turbine according to various embodiments.

FIG. 2 shows a schematic cross-sectional depiction of a steam turbine diaphragm nozzle segment according to various embodiments.

FIG. 3 shows a schematic cross-sectional depiction of a steam turbine diaphragm segment according to various additional embodiments.

FIG. 4 shows a close-up schematic cross-sectional depiction of the steam turbine diaphragm segment of FIG. 3

FIG. 5 shows a schematic three-dimensional perspective view of a steam turbine diaphragm segment according to various embodiments.

FIG. 6 shows a schematic cross-sectional depiction of a steam turbine diaphragm segment according to various additional embodiments

FIG. 7 shows a schematic cross-sectional depiction of a steam turbine diaphragm segment according to various other embodiments.

FIG. 8 shows a schematic cross-sectional depiction of a steam turbine diaphragm segment according to various additional embodiments.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The subject matter disclosed herein relates to steam turbines. Specifically, the subject matter disclosed herein relates to nozzle segments in steam turbines.

According to various embodiments of the disclosure, a steam turbine nozzle segment includes an airfoil and a sidewall coupled (e.g., integral in some cases) with the airfoil, where the sidewall includes an axially upstream-extending (forward) hook and a first notch (also referred to as a first groove) adjacent the axially forward-extending hook, as well as an axially downstream-extending (aft) hook and a second notch adjacent the axially downstream-extending hook. The forward hook is sized to engage a first slot in a nozzle cover, and the aft hook is sized to engage a second slot in the turbine's diaphragm ring. In various embodiments, the nozzle cover is a separate component connected to the outer ring, which can be coupled and decoupled with the outer ring, e.g., to enhance the ability to access the nozzle segment. However, in other cases, the nozzle cover is an integral component with the outer ring (e.g., they are formed of a piece of common material such as low carbon or alloy steel). In various embodiments, the sidewall further includes an axially upstream-extending (forward) flange extending substantially an entirety of the axial length of the forward flow path (between airfoil and next stage nozzle). Some embodiments include a lug member coupling the nozzle segment to the turbine diaphragm ring, e.g., to prevent rotation of the nozzle segment relative to that ring.

As denoted in these Figures, the “A” axis represents axial orientation (along the axis of the turbine rotor, omitted for clarity). As used herein, the terms “axial” and/or “axially” refer to the relative position/direction of objects along axis A, which is substantially parallel with the axis of rotation of the turbomachine (in particular, the rotor section). As further used herein, the terms “radial” and/or “radially” refer to the relative position/direction of objects along axis (r), which is substantially perpendicular with axis A and intersects axis A at only one location. Additionally, the terms “circumferential” and/or “circumferentially” refer to the relative position/direction of objects along a circumference (c) which surrounds axis A but does not intersect the axis A at any location. Identically labeled elements in the Figures depict substantially similar (e.g., identical) components.

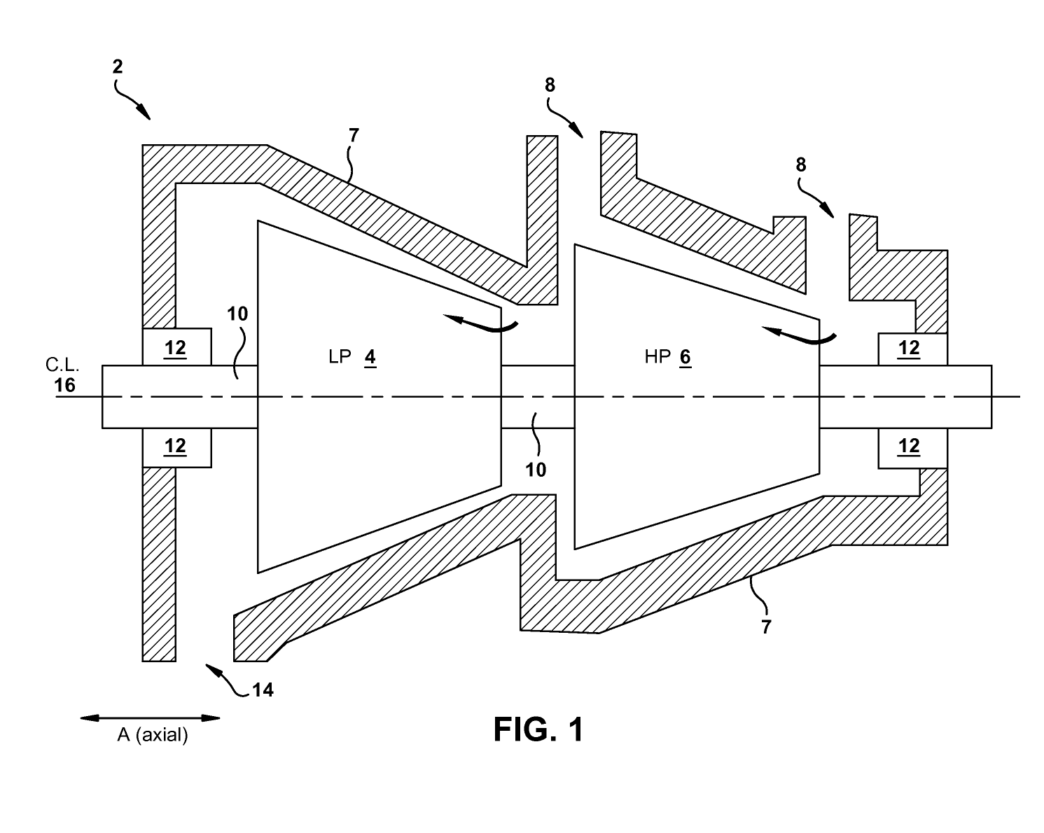

Turning to FIG. 1, a partial cross-sectional schematic view of steam turbine 2 (e.g., a high-pressure/intermediate-pressure steam turbine) is shown. Steam turbine 2 may include, for example, a low pressure (LP) section 4 and a high pressure (HP) section 6. The LP section 4 and HP section 6 are at least partially encased in casing 7. Steam may enter the HP section 6 and LP section 4 via one or more inlets 8 in casing 7, and flow axially downstream from the inlet(s) 8. In some embodiments, the HP section 6 and LP section 4 are joined by a common shaft 10, which may contact bearings 12, allowing for rotation of the shaft 10, as working fluid (steam) forces rotation of the blades within each of the LP section 4 and the HP section 6. After performing mechanical work on the blades within the LP section 4 and the HP section 6, working fluid (e.g., steam) may exit through outlet 14 in casing 7. The center line (CL) 16 of the HP section 6 and LP section 4 is shown as a reference point. Both the LP section 4 and the HP section 6 can include diaphragm assemblies, which are contained within segments of casing 7.

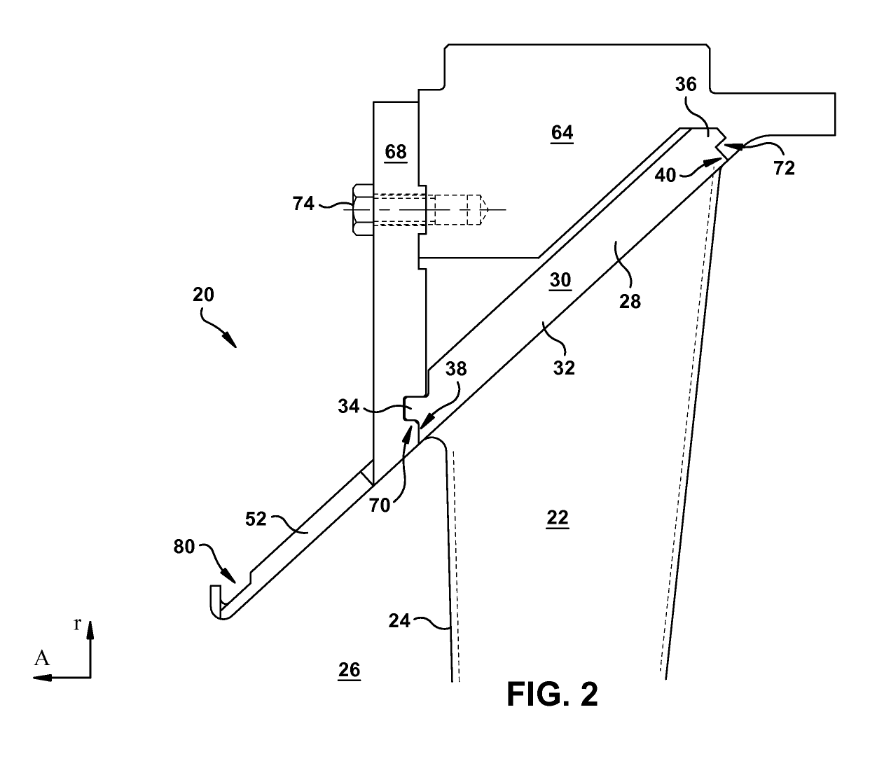

FIG. 2 shows a schematic cross-sectional depiction of a steam turbine diaphragm nozzle segment (or simply, nozzle segment) 20 according to various embodiments. As shown, nozzle segment 20 can include an airfoil 22 having a contact surface 24 for directing a flow of working fluid (e.g., steam) through a flow path 26. Nozzle segment 20 can also include a sidewall 28 coupled with the airfoil 22 and at least partially radially outboard of airfoil 22 (along “r” axis). The sidewall 28 can include a body 30 coupled with the airfoil 22, which in various embodiments is welded or otherwise affixed to a radially outer surface 32 of airfoil, and in other embodiments is integrally formed with the airfoil 22 (e.g., via casting, forging or other conventional methods). In any case, sidewall 28 includes body 30, as well as an axially upstream-extending hook (forward hook) 34 extending axially from body 30 in a first axial direction (“A” axis), and an axially downstream-extending hook (aft hook) 36 extending axially from body 30 in a direction opposite the forward hook 34. Sidewall 28 can further include a first notch 38 adjacent axially upstream-extending hook (forward hook) 34 and a second notch 40 adjacent axially downstream-extending hook (aft hook) 36. First notch 38 can be located radially inboard of forward hook 34, and second notch 40 can be located radially inboard of aft hook 36 in various embodiments.

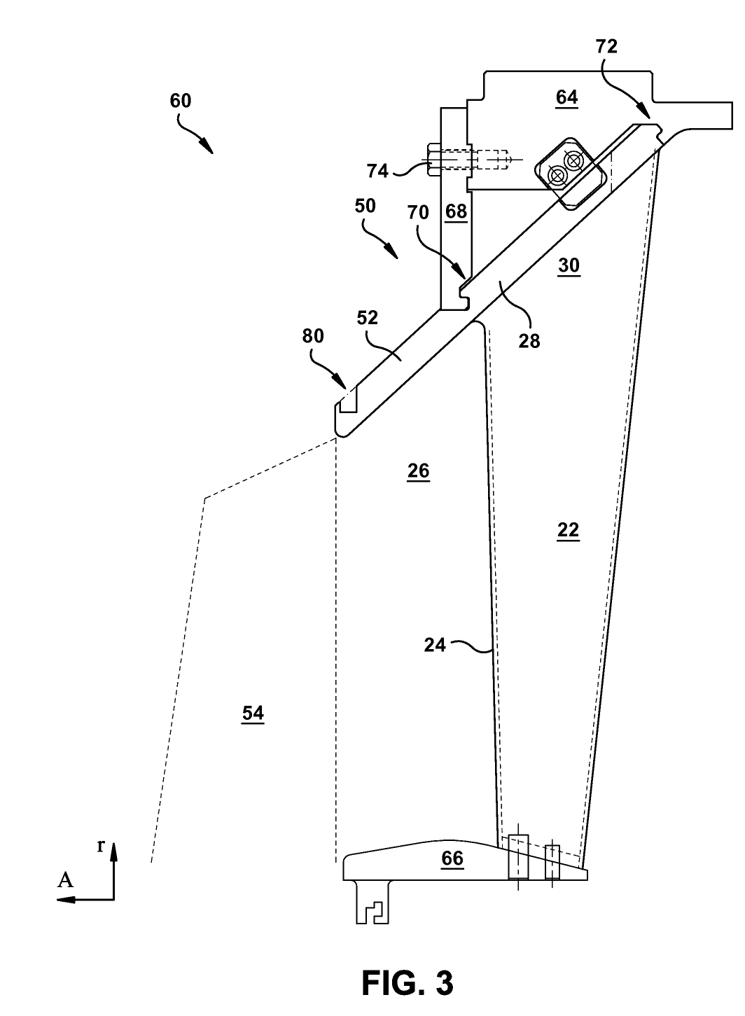

In various embodiments, as shown in the schematic depiction in FIG. 3, a nozzle segment 50 can include a sidewall 28 with an axially upstream-extending flange (forward flange) 52, which extends substantially an entirety of the axial length of flow path 26. That is, forward flange 52 can extend axially between airfoil 22 and an adjacent turbine bucket 54 (shown in phantom). In various embodiments, forward flange 52 can extend axially beyond forward hook 34 and first notch 38, where forward hook 34 extends toward flow path 26 (in axial direction A).

FIG. 3 also depicts a steam turbine diaphragm segment 60, including a diaphragm 62 having an outer ring (turbine outer ring) 64 and an inner ring (turbine inner ring) 66. Diaphragm 62 can be contained within a casing (e.g., casing 7, FIG. 1) as is known in the art. Outer ring 64 is located radially outboard of inner ring 66, and collectively, inner ring 66 and outer ring 64 house a plurality of nozzle segments (e.g., nozzle segments 20, 50, etc.) as described herein. Diaphragm segment 60 can further include a nozzle cover 68 coupled with outer ring 64 and nozzle segment 50, which is also depicted in FIG. 2 as coupled with nozzle segment 20. As shown in FIGS. 2 and 3, nozzle cover 68 is coupled with outer ring 64 and nozzle segment (nozzle segment 20 in FIG. 2 and nozzle segment 50 in FIG. 3), and includes a first slot 70 engaging the forward hook 34. In various embodiments, first slot 70 substantially complements forward hook 34 such that the surfaces of first slot 70 and forward hook 34 are coincident with one another when engaged. As is also depicted in FIGS. 2 and 3, outer ring 64 includes a second slot 72 engaging the aft hook 36. In various embodiments, first slot second slot 72 substantially complements aft hook 36 such that the surfaces of second slot 72 and aft hook 36 are coincident with one another when engaged. In some cases, nozzle cover 68 is bolted, screwed, affixed or otherwise coupled to outer ring 64. In one example scenario, nozzle cover 68 is bolted to outer ring 64 by coupling member 74, which may be an axially-extending bolt to ease access and/or removal of nozzle cover 68 as well as nozzle segments 20, 50. In some cases, inner ring 66 is pinned, bolted or otherwise affixed to the radially inner region of airfoil 22 (as shown in FIG. 3). However, inner ring 66 could be formed integrally with airfoil 22 in various embodiments, as described herein and known in the art.

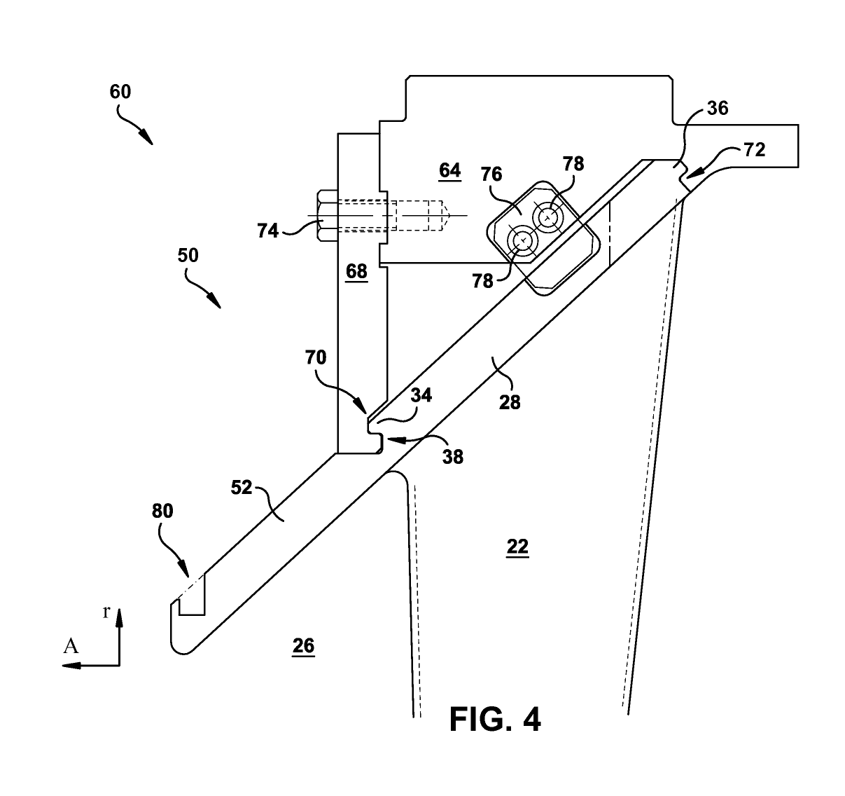

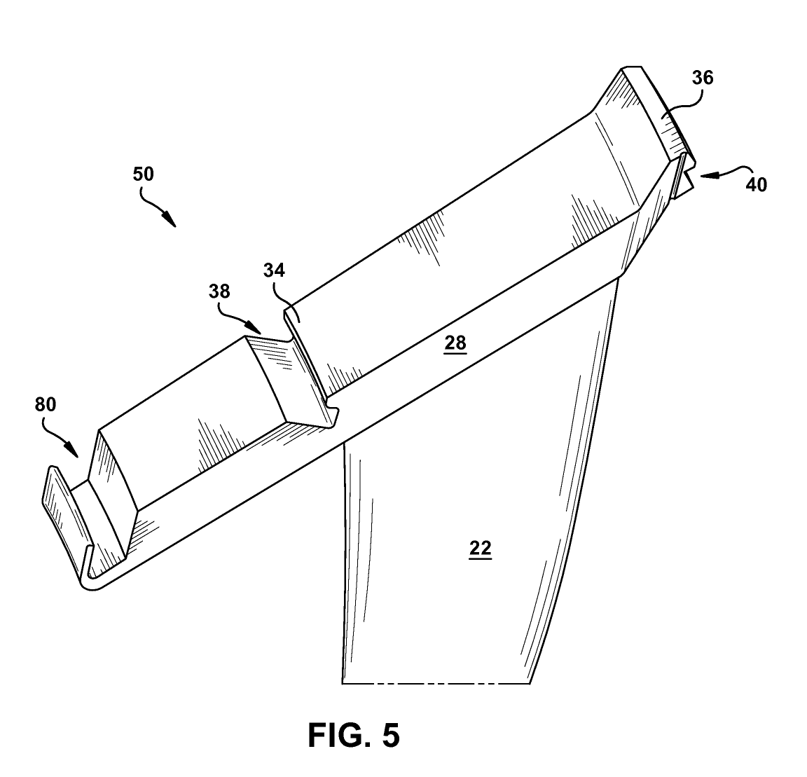

FIG. 4 shows a close-up depiction of nozzle segment 50 in FIG. 3, further illustrating a lug member 76 coupling sidewall 28 with outer ring 64. In some cases, lug member 76 can include a bracket or other coupling mechanism (e.g., formed of steel or composite metal) for at least partially restricting movement of sidewall 28 relative to outer ring 64 (e.g., to prevent unwanted rotation of nozzle segment 20). In some cases, lug member 76 is retained by circumferentially extending members 78 (e.g., bolts or screws, extending into or out of the page, perpendicular to radial direction, “r”). FIG. 5 shows a schematic three-dimensional depiction of nozzle segment 50 in FIGS. 3-4, with clearer illustration of forward flange 52. As shown, forward flange 52 can include a groove 80 extending circumferentially entirely across sidewall 28 (into/out of page, extending perpendicular to radial direction, “r”). In some cases, groove 80 can collect and redistribute moisture within the steam turbine to improve performance.

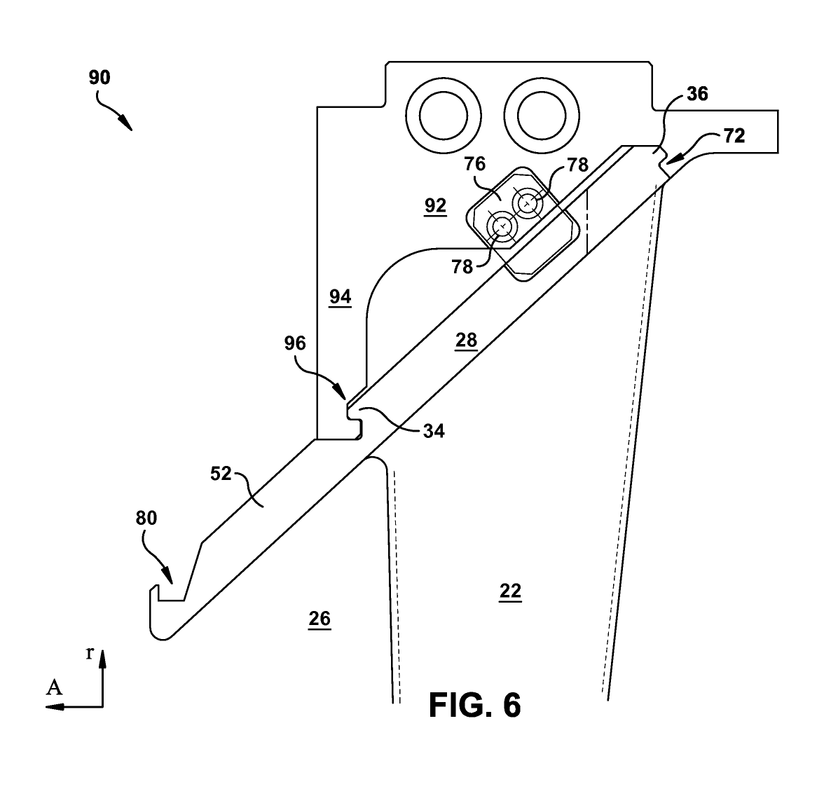

In some other embodiments, as shown in the diaphragm segment 90 of FIG. 6, a diaphragm outer ring 92 can include an integral forward cover portion 94 (where forward refers to axially upstream, as noted here). In these cases, outer ring 92 includes a first slot 96 engaging forward hook 34 and a second slot 72 engaging aft hook 36.

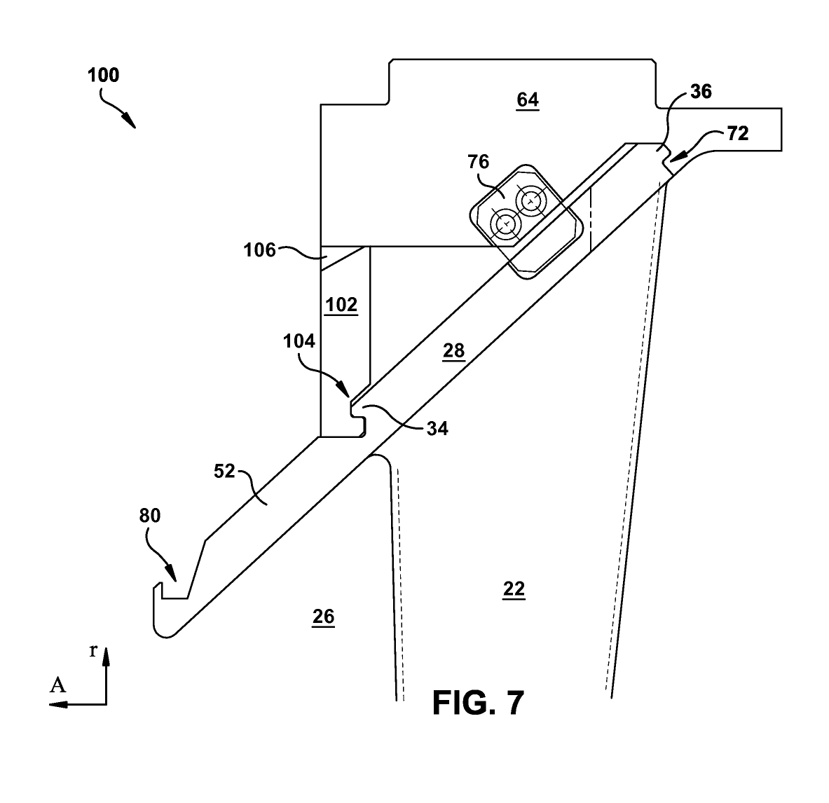

In another embodiment, as shown in the diaphragm segment 100 of FIG. 7, a forward cover 102 including a slot 104 for engaging forward hook 34 is welded to outer ring 64 (weld 106 shown). In these cases, forming and/or removing weld 106 can allow for access to nozzle segment 20.

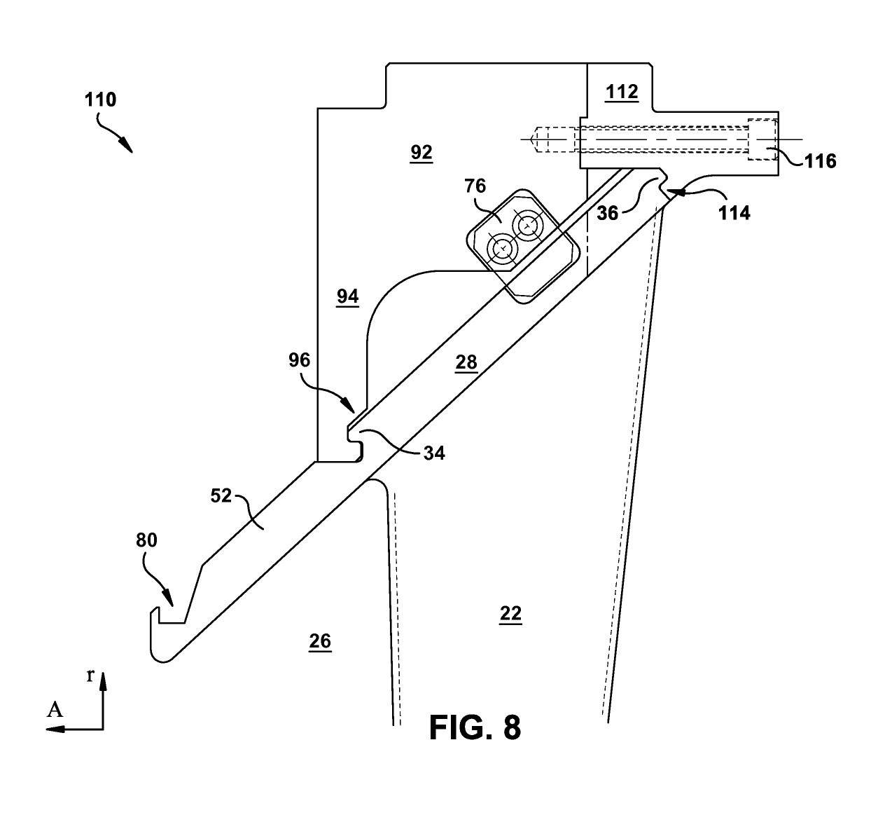

In yet further embodiments, as shown in the diaphragm segment 110 of FIG. 8, a rear cover 112 including a slot 114 for engaging aft hook 36 is coupled to outer ring 92 (having integral forward cover portion 94). Rear cover 112 can be coupled to outer ring 92 via coupling member 116, which can include an axially extending bolt, pin, or screw.

As noted herein, when compared with conventional diaphragm segments, assemblies and steam turbines, various aspects of the disclosure can provide for improved manufacturability, maintenance and replacement of parts. In some cases, the nozzle segments (e.g., nozzle segments 20, 50, etc.) disclosed herein can allow for relatively shorter turn-around time in replacing nozzle components (e.g., nozzle segments 20, 50, etc.), as conventional weld joints are replaced by complementary hook mechanisms. Further, the addition of forward flange 52 shown and described herein can provide enhanced performance when compared with conventional assemblies, as forward flange 52 can help to seal the flow path 26 and reduce steam leakage (and prevent unwanted steam flow disruption). The embodiments disclosed herein can reduce time spent in installation, maintenance and/or replacement of parts, which further reduces costs and enhances the efficiency of steam turbines employing these embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A steam turbine diaphragm nozzle segment comprising:
an airfoil having a contact surface for directing a flow of working fluid through a flow path; and
a sidewall coupled with the airfoil and at least partially radially outboard of the airfoil, the sidewall having:
a body contacting the airfoil;
an axially upstream-extending hook extending axially from the body;
a first notch adjacent the axially upstream-extending hook;
an axially downstream-extending hook extending axially from the body; and
a second notch adjacent the axially downstream-extending hook.

2. The steam turbine diaphragm nozzle segment of claim 1, wherein the sidewall further comprises an axially upstream-extending flange extending substantially an entirety of an axial length of the flow path.

3. The steam turbine diaphragm nozzle segment of claim 2, wherein the flow path extends axially between the airfoil and an adjacent turbine bucket.

4. The steam turbine diaphragm nozzle segment of claim 2, wherein the axially upstream-extending flange extends axially beyond the axially upstream-extending hook and the first notch.

5. The steam turbine diaphragm nozzle segment of claim 1, wherein the axially upstream-extending hook extends axially from the body in an opposite direction from the axially downstream-extending hook.

6. The steam turbine diaphragm nozzle segment of claim 1, wherein the axially upstream-extending hook extends toward the flow path.

7. The steam turbine diaphragm nozzle segment of claim 1, wherein the axially upstream-extending hook is sized to engage a first slot in a nozzle cover.

8. The steam turbine diaphragm nozzle segment of claim 1, wherein the axially downstream-extending hook is sized to engage a second slot in a turbine outer ring.

9. A steam turbine diaphragm segment comprising:
an outer ring;
an inner ring within the outer ring; and
at least one diaphragm nozzle segment coupled to the inner ring and the outer ring, the at least one diaphragm nozzle segment having:
an airfoil with a contact surface for directing a flow of working fluid through a flow path;
a first sidewall coupled with the airfoil and at least partially radially outboard of the airfoil, the first sidewall coupled with the outer ring, wherein the first sidewall includes:
a body contacting the airfoil;
an axially upstream-extending hook extending axially from the body;
a first notch adjacent the axially upstream-extending hook;
an axially downstream-extending hook extending axially from the body; and
a second notch adjacent the axially downstream-extending hook; and
a second sidewall coupling the airfoil with the inner ring.

10. The steam turbine diaphragm segment of claim 9, wherein the first sidewall further comprises an axially upstream-extending flange extending substantially an entirety of an axial length of the flow path.

11. The steam turbine diaphragm segment of claim 10, wherein the flow path extends axially between the airfoil and an adjacent turbine bucket.

12. The steam turbine diaphragm segment of claim 10, wherein the axially upstream-extending flange extends axially beyond the axially upstream-extending hook and the first notch.

13. The steam turbine diaphragm segment of claim 9, wherein the axially upstream-extending hook extends axially from the body in an opposite direction from the axially downstream-extending hook.

14. The steam turbine diaphragm segment of claim 9, further comprising:
a nozzle cover coupled with the outer ring and the at least one diaphragm nozzle segment, the nozzle cover including a first slot engaging the axially upstream-extending hook, wherein the outer ring includes a second slot engaging the axially downstream-extending hook.

15. The steam turbine diaphragm segment of claim 9, wherein the outer ring includes a first slot engaging the axially upstream-extending hook and a second slot engaging the axially downstream-extending hook.

16. A steam turbine comprising:
a rotor;
a turbine casing at least partially surrounding the rotor; and
a diaphragm segment between the turbine casing and the rotor, the diaphragm segment having:
an outer ring;
an inner ring within the outer ring; and
at least one diaphragm nozzle segment coupled to the inner ring and the outer ring, the at least one diaphragm nozzle segment having:
an airfoil with a contact surface for directing a flow of working fluid through a flow path;
a first sidewall coupled with the airfoil and at least partially radially outboard of the airfoil, the first sidewall coupled with the outer ring, wherein the first sidewall includes:
a body contacting the airfoil;
an axially upstream-extending hook extending axially from the body;
a first notch adjacent the axially upstream-extending hook;
an axially downstream-extending hook extending axially from the body; and
a second notch adjacent the axially downstream-extending hook; and
a second sidewall coupling the airfoil with the inner ring.

17. The steam turbine of claim 15, wherein the first sidewall further comprises an axially upstream-extending flange extending substantially an entirety of an axial length of the flow path, wherein the flow path extends axially between the airfoil and an adjacent turbine bucket.

18. The steam turbine of claim 17, wherein the axially upstream-extending flange extends axially beyond the axially upstream-extending hook and the first notch.

19. The steam turbine of claim 15, further comprising:
a nozzle cover coupled with the outer ring and the at least one diaphragm nozzle segment, the nozzle cover including a first slot engaging the axially upstream-extending hook, wherein the outer ring includes a second slot engaging the axially downstream-extending hook; and
a lug member connecting the outer ring with the first sidewall for stabilizing the at least one diaphragm nozzle segment.

20. The steam turbine diaphragm segment of claim 16, wherein the outer ring includes a first slot engaging the axially upstream-extending hook and a second slot engaging the axially downstream-extending hook.
